(19) United States
(12) Patent Application Publication
(10) Pub. No.: US 2025/0075678 A1
(43) Pub. Date: Mar. 6, 2025

(54) ADDITIONAL HYDRAULIC DEVICE FOR A PITCH SYSTEM, A PITCH SYSTEM AND WIND TURBINE

(71) Applicant: HAWE Hydraulik SE, Aschheim (DE)

(72) Inventors: Andreas Nocker, Aschheim (DE); Jesper Berg Hansen, Aschheim (DE); Thomas Wechsel, Aschheim (DE); Lucas Schubart, Aschheim (DE)

(73) Assignee: HAWE Hydraulik SE, Aschheim (DE)

(21) Appl. No.: 18/824,293

(22) Filed: Sep. 4, 2024

(30) Foreign Application Priority Data
Sep. 5, 2023 (DE) 10 2023 208 554.2

(51) Int. Cl. F03D 1/06; F03D 9/25; F15B 1/04; F15B 1/26

(52) U.S. Cl. CPC F03D 1/0669; F03D 9/25; F15B 1/04; F15B 1/26; F05B 2260/70

(57) ABSTRACT

An additional hydraulic device for a pitch system of a wind turbine, the additional hydraulic device including a hydraulic motor, a hydraulic accumulator for storing hydraulic energy, a valve unit, a return line and a reservoir. The return line is connected to the reservoir. The valve unit is switchable to a drive switching position, and the hydraulic motor is connected to the hydraulic accumulator in the drive switching position. The energy stored in the hydraulic accumulator drives the hydraulic motor in the drive switching position so that the hydraulic motor delivers an additional force component.

### CROSS-REFERENCE TO RELATED APPLICATIONS

This application claims priority to German Patent Application No. 10 2023 208 554.2, filed Sep. 5, 2023, which is hereby incorporated by reference in its entirety.

### FIELD

The present disclosure relates to an additional hydraulic device for a pitch system.

### BACKGROUND

Pitch systems (e.g., pitch control systems) are configured to adapt the aerodynamic angle of attack on one or more rotor blades of the wind turbine and thus to adjust the so-called pitch. For this purpose, the rotor blades are rotatably disposed on a rotor hub of a rotor of the wind turbine via a pitch bearing and a pitch gear. The pitch system changes the pitch of the rotor blades as a function of the instantaneous wind speed in order to operate the wind turbine with the best possible efficiency and therefore with largely constant rated power. For a number of purposes, the pitch angle of the rotor blades are adjusted to obtain the desired lift of the blades, including bringing the rotor to stop, limit energy intake from the wind to the blade, maintenance and so on. In other words, the angular position is adjusted to the wind direction.

In addition, the pitch systems are also configured to prevent damage to the wind turbine in strong winds by turning the rotor blades out of the wind, e.g., into the so-called feather position. This interrupts the lift of the rotor blades and the rotor comes to a standstill, possibly with the support of a brake.

### SUMMARY

In an aspect, a hydraulic device for a pitch system of a wind turbine, the hydraulic device including a hydraulic motor, a hydraulic accumulator for storing hydraulic energy, a valve unit, a return line, a reservoir connected to the return line, and a generator. The valve unit is switchable to a drive switching position, the hydraulic motor is connected to the hydraulic accumulator in the drive switching position, and the energy stored in the hydraulic accumulator drives the hydraulic motor in the drive switching position so that the hydraulic motor delivers an additional force component. The additional force component is applied to the generator to cause the generator to supply electric energy to the pitch system.

In another aspect, a hydraulic device for a pitch system of a wind turbine includes a hydraulic motor having a first connection and a second connection, a hydraulic accumulator for storing hydraulic energy, a valve unit, a return line, a reservoir connected to the return line, and a circulation line. The first connection is connected to the second connection via the circulation line, the valve unit is switchable to a drive switching position and a normal operation switching position, the hydraulic motor is connected to the hydraulic accumulator in the drive switching position and the circulation line is blocked in the drive switching position, the energy stored in the hydraulic accumulator drives the hydraulic motor in the drive switching position so that the hydraulic motor delivers an additional force component, and the hydraulic motor is separated from the hydraulic accumulator in the normal operation switching position and wherein the circulation line is released in the normal operation switching position.

In another aspect, a pitch system for a wind turbine includes a hydraulic device having a hydraulic motor, a hydraulic accumulator for storing hydraulic energy, a valve unit, a return line, a reservoir connected to the return line, and a generator. The valve unit is switchable to a drive switching position, the hydraulic motor is connected to the hydraulic accumulator in the drive switching position, and the energy stored in the hydraulic accumulator drives the hydraulic motor in the drive switching position so that the hydraulic motor delivers an additional force component. The additional force component is applied to the generator to cause the generator to supply electric energy to the pitch system.

In another aspect, a wind turbine includes at least one rotor blade and a pitch system. The pitch system includes a hydraulic device. The hydraulic device includes a hydraulic motor, a hydraulic accumulator for storing hydraulic energy, a valve unit, a return line, a reservoir connected to the return line, and a generator. The valve unit is switchable to a drive switching position, the hydraulic motor is connected to the hydraulic accumulator in the drive switching position, and the energy stored in the hydraulic accumulator drives the hydraulic motor in the drive switching position so that the hydraulic motor delivers an additional force component. The additional force component is applied to the generator to cause the generator to supply electric energy to the pitch system.

### BRIEF DESCRIPTION OF THE DRAWINGS

A full and enabling disclosure, including the best mode thereof, directed to one of ordinary skill in the art, is set forth in the specification, which refers to the appended Figures, in which:

FIG. 1 is a side view of a wind turbine;

FIG. 2 is a pitch system with an additional hydraulic device according to a first embodiment;

FIG. 3 is a variant of the pitch system shown in FIG. 2;

FIG. 4 is a pitch system with an additional hydraulic device according to a second embodiment;

FIG. 5 is a pitch system with an additional hydraulic device according to a third embodiment;

FIG. 6 is a pitch system with an additional hydraulic device according to a fourth embodiment;

FIG. 7 is a pitch system with an additional hydraulic device according to a fifth embodiment; and

FIG. 8 is a pitch system with an additional hydraulic device according to a sixth embodiment.

### DETAILED DESCRIPTION

In general, pitch systems comprise a drive unit configured to adapt the pitch of one or all rotor blades of the wind turbine. The drive units known from the prior art are either of the electrical type of the hydraulic type e.g., an electric pitch system is provided comprising an electric motor or a hydraulic pitch systems is provided comprising hydraulic actuators like cylinders. If an electric pitch system is provided, the electric motor may either be an alternating current (AC) electric motor or a direct current (DC) electric motor. Under any event, the pitch system also needs to be configured to reliably adapt the pitch of the rotor blades and to turn the rotor blades into the feather position via an emergency stop function. For instance, in case the electrical power is lost due to malfunction, the wind turbine needs to be stopped to prevent any damage or dangerous situations. Therefore, the pitch system or the wind turbine respectively comprises a backup power supply to allow to energize the drive unit even in case the electrical grid connection is lost. Often, supercapacitors are provided to act as the backup power supply. However, the supercapacitors are expensive and need to be replaced in short intervals. Besides that, further factors like temperature, number of usage of the supercapacitors or dynamics of the electrical drive unit may further impair the functionality of such systems.

Furthermore, it needs to be considered that although AC electrical motors have comparably low cost, they are in general less suitable for an emergency stop use as described above, due to the fact that they rely on AC-drives to operate during the emergency movement. Such drives are complex structures and it can be difficult to reach the desired performance level and avoid common cause failures. Furthermore, a DC/AC power inverter also necessarily needs to be provided. In contrast thereto, DC electrical motors have higher costs, but are reliable during emergency stop use, since the poles of the backup power supply may directly be connected to the DC electrical motor.

Hence, there is the need to provide a reliable system with reduced costs allowing for a reliable emergency stop use with the known pitch systems. Accordingly, it is the objective of the present disclosure to provide such a system.

The solution of the problem is achieved with an additional hydraulic device according to claim 1 or claim 2. Furthermore, the solution is also achieved with a pitch system according to claim 9 and a wind turbine according to claim 13. Preferable embodiments are described in the dependent claims.

According to a first aspect of the disclosure, an additional hydraulic device for a pitch system of a wind turbine is provided. The additional hydraulic device comprises a hydraulic motor, a hydraulic accumulator for storing hydraulic energy, a valve unit, a return line and a reservoir. The return line is connected to the reservoir and the valve unit is switchable to a drive switching position. The hydraulic motor is connected to the hydraulic accumulator in the drive switching position, wherein the energy stored in the hydraulic accumulator drives the hydraulic motor in the drive switching position so that the hydraulic motor delivers an additional force component. The additional hydraulic system comprises a generator, wherein the additional force component is applied to the generator, wherein the generator is configured to supply electric energy to the pitch system.

According to a second aspect of the disclosure, an additional hydraulic device for a pitch system of a wind turbine is provided. The additional hydraulic device comprises a hydraulic motor having a first connection and a second connection, a hydraulic accumulator for storing hydraulic energy, a valve unit, a return line, a circulation line and a reservoir. The connection line connects the first connection and the second connection. The return line is connected to the reservoir and the valve unit is switchable to a drive switching position and a normal operation switching position. The hydraulic motor is connected to the hydraulic accumulator in the drive switching position and the circulation line is blocked in the drive switching position, wherein the energy stored in the hydraulic accumulator drives the hydraulic motor in the drive switching position so that the hydraulic motor delivers an additional force component. In the normal operation switching position, the hydraulic accumulator is separated from the hydraulic motor and the circulation line is released.

In other words, the hydraulic accumulator stores hydraulic energy which is transferred into the additional force component via the hydraulic motor in case needed. As the hydraulic energy in the hydraulic accumulator is stored purely mechanical, there is no need for storing electric energy for emergency stop use e.g., in supercapacitors. Rather, for performing an emergency stop the valve unit is simply switched into the drive switching position to release the pressurized hydraulic fluid stored in the hydraulic accumulator to the hydraulic motor to generate the additional force component which may adapt the pitch of one or all rotor blades as described above.

According to the first aspect, there is no need for a direct coupling between the hydraulic motor and the electric motor of the pitch system. Rather, only an electrical connection between the generator and the electric motor is necessary. Preferably, the electric motor is an AC motor so that there is no need for an auxiliary rectifier. In addition, the generator can also be utilized as a motor for driving the hydraulic motor in reverse to act like a pump and hence, to charge the hydraulic accumulator. Further, the position of the rotor blades can be controlled.

According to the second aspect, a lossless operation in the normal operation switching position is achieved, as the hydraulic fluid may circulate in the circulation line.

Hence, the additional hydraulic device can be used as a reliable backup power supply unit. Furthermore, the hydraulic components of the additional hydraulic device have a lower cost compared to supercapacitors and in addition have a lifetime that exceed the expected life time of the wind turbine or pitch system respectively. Furthermore, it needs to be emphasized that the term “additional force component” does not imply that a further force component is always present. Rather, the additional force component according to the present disclosure may be the only force component during specific situations e.g., during an emergency situation or an emergency stop use respectively.

Preferably, the additional hydraulic device comprises a variable pressure line. Preferably, the hydraulic motor is a hydraulic motor with variable displacement and is connected to the variable pressure line, wherein the displacement depends on the pressure in the variable pressure line. Thus, hydraulic motor with variable displacement utilizes the accumulator capacity efficiently. The control of the hydraulic motor with variable displacement is done with a pressure feedback via the variable pressure line. The pressure feedback may be established e.g., by a variable pump, a constant pump or a similar non-electrical solution. In this regard, the addition hydraulic device preferably the additional hydraulic device comprises a constant pump in form of a constant displacement pump connected to the variable pressure line, wherein the constant displacement pump and the hydraulic motor are connected in series, preferably via a common shaft. Thus, the constant displacement pump establishes the pressure in the variable pressure line to control the hydraulic motor.

Preferably, the hydraulic motor with variable displacement is a bidirectional hydraulic motor with variable displacement. The valve unit may be switchable into a first run switch position and into a second run switch position. The additional force component of the hydraulic motor may be a torque and the torque may be output in a first rotational direction in the first run switch position and in a second rotational direction in the second run switch position. Hence, the hydraulic motor may be pressurized via the valve unit in either direction. This configuration not only allows to perform an emergency stop as described above, but further may be used to add the respective torque output by the hydraulic motor to the drive torque of the electric motor of the pitch system in either direction. Consequently, the electric motor and additional components of the pitch system can be configured for a lower “peak” torque, while still being intended for position tracking, although an amount of the total torque needed is provided by the hydraulic motor. The hydraulic motor also supplies torque in case of an emergency stop.

Preferably, the hydraulic motor is a reversible hydraulic motor, wherein the valve unit is switchable to a charging switch position connecting the reversible hydraulic motor to the return line and the hydraulic accumulator. Preferably, an electric motor of the pitch system of the wind turbine is configured to drive the reversible hydraulic motor in the charging switch position so that the reversible hydraulic motor charges the hydraulic accumulator with hydraulic energy in the charging switch position. Hence, the electric motor of the pitch system may be used to drive the reversible hydraulic motor in reverse so that it acts like a hydraulic pump in order to charge the hydraulic accumulator. Thus, there is no further need for a separate charging pump which overall saves costs.

In this regard, it may be preferable that the reservoir is connected to the reversible hydraulic motor via a bypass line, wherein a check valve opening in the direction of flow to the reversible hydraulic motor is disposed in the bypass line. This hinders unintended backflow to the reservoir during normal operation mode but allows to draw hydraulic fluid from the reservoir when charging the hydraulic accumulator.

The pitch system for a wind turbine according to the present disclosure includes at least one additional hydraulic device according to the present disclosure as described above. Depending on the configuration, one or more additional hydraulic devices are provided which are associated with one or more of the rotor blades. For instance, only one additional hydraulic device may be provided which supports the pitch system of several rotor blades. Preferably, the pitch system comprises an electric motor for adapting the pitch of at least one rotor blade of the wind turbine.

Preferably, the electric motor and the hydraulic motor are connected in series, preferably via a common shaft. Preferably, the pitch system further comprises a clutch for separating the electric motor and/or the hydraulic motor from the at least one rotor blade. Preferably, the pitch system further comprises an inverter connecting the electric motor to the power grid. Preferably, the pitch system further comprises a brake and a gear box.

The wind turbine according to the present disclosure includes at least one rotor blade and a pitch system as described above.

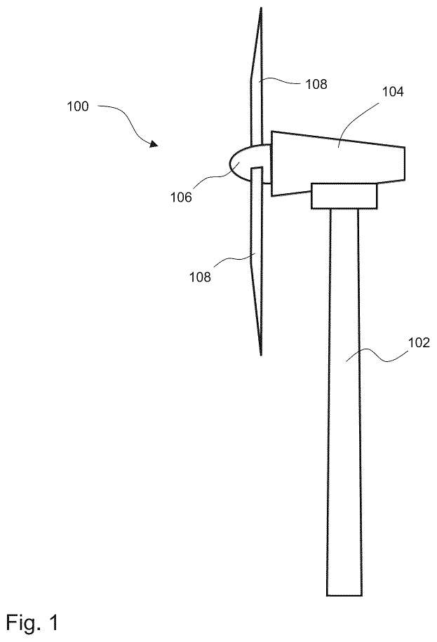

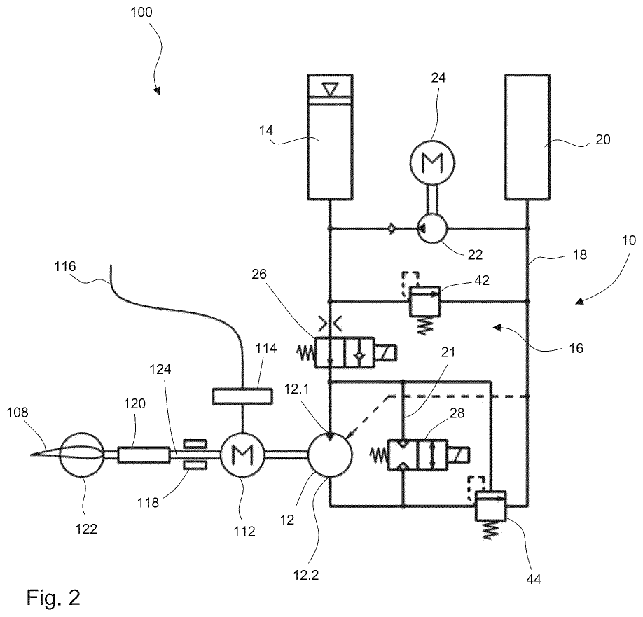

FIG. 1 depicts a side view of a wind turbine 100 according to the present disclosure. The wind turbine 100 comprises a tower 102 and a nacelle 104 mounted to the tower 102. A hub 106 is rotatably supported by the nacelle 104. The wind turbine 100 further comprises a plurality of rotor blades 108 which are mounted to the hub 106. A pitch system 110 (see Figures. 2 to 8) is provided which is configured to adapt the aerodynamic angle of attack of one or all rotor blades 108 of the wind turbine 100. The pitch system 110 changes the pitch of the rotor blades 108 as a function of the instantaneous wind speed in order to operate the wind turbine 100 with the best possible efficiency and therefore with largely constant rated power. For this purpose, the rotor blades 108 are adjusted in their angular position relative to the hub 106 via the pitch system 110 in such a way that the desired lift is generated. The pitch system 100 is further configured to prevent damage to the wind turbine 100 in strong winds by turning the rotor blades 108 out of the wind, i.e. into the so-called feather position. This interrupts the lift of the rotor blades 108 and the rotor comes to a standstill.

In particular, the pitch system 110 comprises a drive unit. In the embodiments shown in FIGS. 2 to 7, the drive unit is an electric motor 112, which is connected to the power grid 116 by an inverter 114. The output torque of the electric motor 112 is transmitted to a pitch gear 122 and the thereto mounted rotor blade 108 via a shaft 124 and the gearbox 120. In addition, a brake 118 is provided which further can exert a braking force on the shaft 124 if needed. Thus, the pitch system 110 may be considered to be an electrical pitch system.

In addition, the pitch system 110 comprises an additional hydraulic device 10 which is configured to deliver an additional force component so that pitching of the rotor blades 108 is still possible as an emergency stop e.g., in the event of electrical power loss.

As shown in FIG. 2, the additional hydraulic device 10 according to a first exemplary embodiment comprises a hydraulic motor 12 having a first connection 12.1 and a second connection 12.2, a hydraulic accumulator 14, a valve unit 16, a return line 18 and a reservoir or tank 20 connected to the return line 18. The first connection 12.1 is connected to the second connection 12.2 via a circulation line 21. The hydraulic accumulator 14 is configured to store hydraulic energy in that pressurized hydraulic fluid is loaded or charged respectively to the hydraulic accumulator 14. When switching the valve unit 16 from a normal operation switching position into a drive switching position, the hydraulic accumulator 14 is connected to the hydraulic motor 12 and drives the hydraulic motor 12 so that the additional force component is generated. In this exemplary embodiment, the additional force component is a torque which is directly applied to the shaft 124, as the electric motor 112 and the hydraulic motor 12 are connected in series. Thus, in case an emergency stop is to be performed in absence of electrical power supply, the valve unit 16 is switched into the drive switching position and the pitch of the rotor blade 108 can be adapted via the torque delivered to the shaft 124 by the hydraulic motor 12.

For loading pressurized hydraulic fluid to the hydraulic accumulator 14 for charging the same, the additional hydraulic device 10 according to the first embodiment comprises a charging pump 22 driven by a motor 24. The charging pump 22 is disposed between the reservoir 20 and the hydraulic accumulator 14. For charging the hydraulic accumulator 14, the valve unit 16 is switched to the charging switch position and the charging pump 22 is energized. The charging pump 22 pumps hydraulic fluid to the hydraulic accumulator 14 via the return line 18 from the reservoir 20. Furthermore, the connection between the hydraulic accumulator 14 and the hydraulic motor 12 is blocked by the valve unit 16 in the charging switch position of the valve unit 16. As soon as sufficient pressurized hydraulic fluid is charged to the hydraulic accumulator 14, the electrical motor 24 driving the charging pump 22 is switched off. The charging status of the hydraulic accumulator 14 may be determined by e.g., pressure sensors or switches as commonly known.

In a normal operation mode without using the additional hydraulic device 10, the valve unit 16 is switched into the normal operation switching position or an idle switching position respectively. Then, the hydraulic motor 12 is idling and driven by the electric motor 112 with only minor losses.

To implement the different switching positions of the valve unit 16, the valve unit 16 comprises a first valve 26 and a second valve 28 in form of an idle valve in this exemplary embodiment. The second valve 28 is disposed in the circulation line 21. In addition, the valve unit 16 comprises first pressure relief valve 42 and a second pressure relief valve 44 in this exemplary embodiment. In this embodiment, the second pressure relief valve 44 is configured as an overcenter valve, but it is not limited thereto. For instance, another valve or an orifice may be provided instead of the second pressure relief valve 44.

In the drive switching position of the valve unit 16, the first valve 26 is switched so that the hydraulic accumulator 14 is connected to the hydraulic motor 12. In addition, the second valve 28 is switched into a blocking position so that the circulation line 21 is blocked. A relief to the reservoir 20 occurs after set pressure is reached at the pressure relief valves 42, 44 which then open the connection to the reservoir 20. As shown in FIG. 2, the drive switching position of the first valve 26 and the second valve 28 is assumed by means of biasing elements only. In other words, in case of an emergency due to e.g., a power shortage the first valve 26 and the second valve 28 are automatically switched into the respective positions.

In the charge switch position of the valve unit 16, the first valve 26 is switched so that the connection between the hydraulic accumulator 14 and the hydraulic motor 12 is blocked in a flow direction from the hydraulic accumulator 14 to the hydraulic motor 12. Hence, only the connection between the reservoir 20 and the hydraulic accumulator 14 via the charging pump 22 is open.

In the normal operation mode, the first valve 26 is switch so that the connection between the hydraulic accumulator 14 and the hydraulic motor 12 is blocked in a flow direction from the hydraulic accumulator 14 to the hydraulic motor 12. Further, the second valve 28 is switched into an idle mode so that the circulation line 21 is released and to allow for lossless operation and for recirculation of the hydraulic fluid.

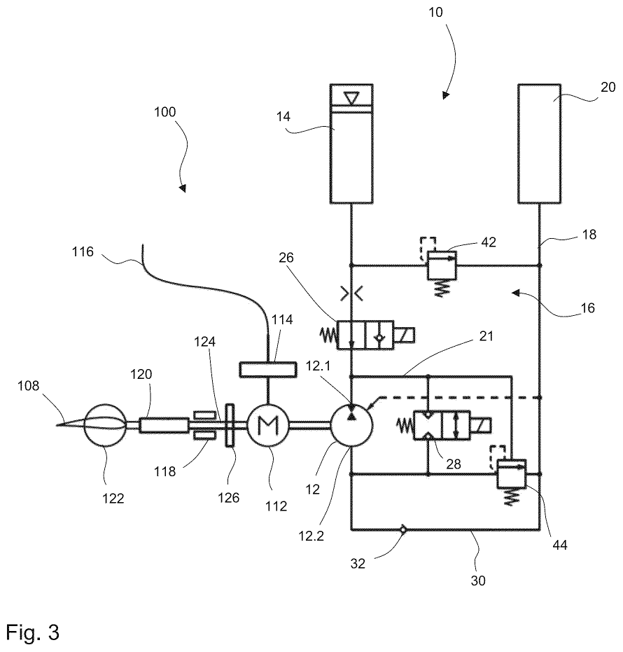

FIG. 3 depicts a variant of the pitch system 110 shown in FIG. 2. Instead of providing a charging pump 22, the hydraulic accumulator 14 can be charged directly by the hydraulic motor 12 in that the hydraulic motor is configured as a reversible hydraulic motor 12. In addition, a bypass line 30 is provided which directly connects the reversible hydraulic motor 12 and the return line 18. A check valve 32 is disposed in the bypass line 30 which opens in a flow direction from the reservoir 20 to the hydraulic motor 12. Furthermore, a clutch or coupling 126 is provided, which may separate the electric motor 112 from the pitch gear 122 and the gearbox 120. In this exemplary embodiment, the clutch 126 is disposed between the brake 118 and electric motor 112. For charging the hydraulic accumulator 14, the valve unit 16 is switched into the charging switch position as described above. Furthermore, the clutch 126 is activated so that any output torque of the electric motor 112 is not transferred to the pitch gear 122 or the gearbox 120. Driving the electric motor 112 will thus result in the reversible hydraulic motor 12 to function as a pump and hydraulic fluid is unloaded from the reservoir 20 via the return line 18 and the bypass line 30 directly to the hydraulic accumulator 14 which is thus charged. As shown, the first valve 26 may be configured so that the flow from the hydraulic motor 12 to the hydraulic accumulator 14 is always possible, but a flow from the hydraulic accumulator 14 to the hydraulic motor 12 is only possible in case the valve unit 16 is in the drive switching position.

After the hydraulic accumulator 14 is sufficiently charged, the valve unit 16 is again switch to a position which blocks the flow from the hydraulic accumulator to the hydraulic motor 12. In addition, the clutch 26 is deactivated so that the connection between the electric motor 112 and the gearbox 120 in the pitch gear 122 is again established. A sufficient charging of the hydraulic accumulator 14 may be monitored by a pressure sensor, a pressure transmitter or a pressure switch. This also allows to continuously monitor that a sufficiently high pressure for an emergency stop is available.

As an alternative, the clutch 126 could be omitted and the hydraulic motor 12 is driven together with the blades 108 by the electrical motor 112 during startup of the wind turbine 100. This will result in a cheaper and simpler embodiment.

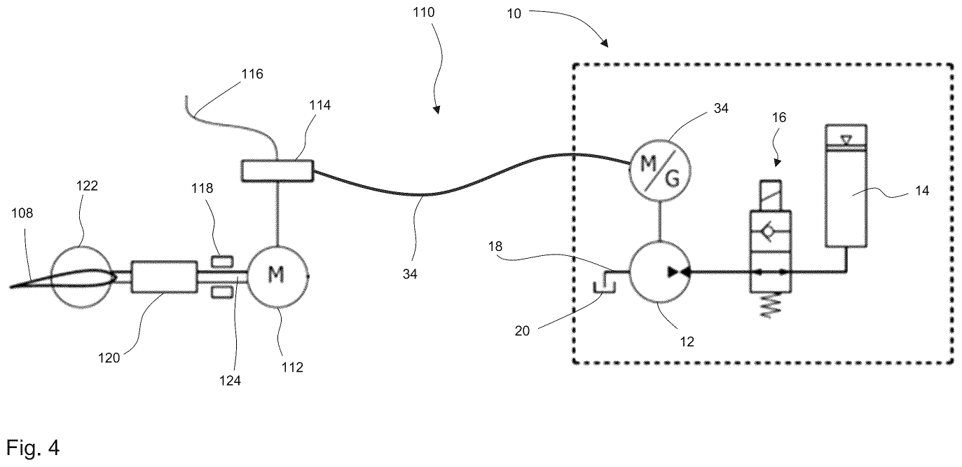

FIG. 4 shows a second embodiment of the pitch system 110 according to the present disclosure. Here, the additional hydraulic device 10 is not connected to the electrical motor 112 via the shaft 124, but rather the connection is configured as an electrical connection 36. Furthermore, the hydraulic motor 12 is configured as a reversible hydraulic motor 12 which is connected to a generator/motor 34. The electrical connection 36 connects the electric motor 112 and the generator/motor 34. During an emergency stop situation, the valve unit 16 is switched to the drive switching position shown in FIG. 4. The pressurized hydraulic fluid from the hydraulic accumulator 14 drives the reversible hydraulic motor and the additional force component delivered by the reversible hydraulic motor 12 drives the generator 34 so that electrical energy is generated and output by the additional hydraulic device 10.

The so generated electrical energy is then conducted to the electrical motor 112 via the connection 36. The electrical motor 112 is thus energized and an adaption of the pitch of the rotor blade 108 is possible. To charge the hydraulic accumulator 14, the generator/motor 34 is energized to act as a motor which drives the reversible hydraulic motor 12 as a pump. Therefore, hydraulic fluid 20 is unloaded from the reservoir 20 and loaded into the hydraulic accumulator 14 which is thus charged. The valve unit 16 is switched into the charging switch position which allows for flow of hydraulic fluid from the hydraulic motor 12 in direction to the hydraulic accumulator 14 but not in the other direction.

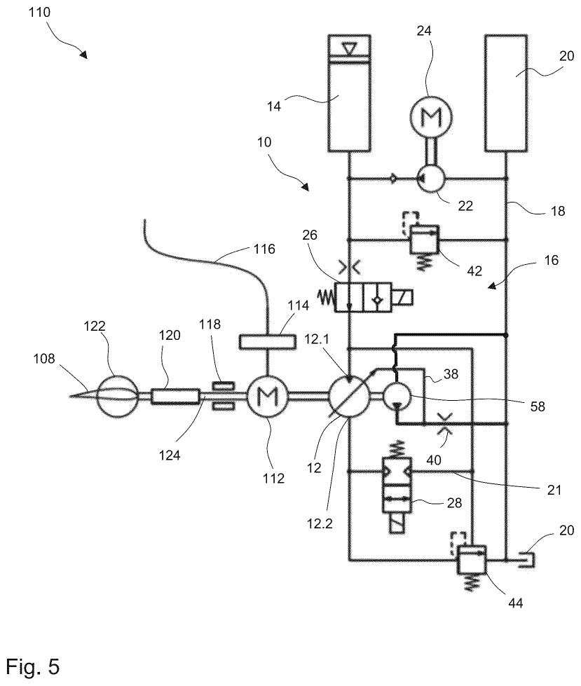

FIG. 5 depicts the pitch system 110 according to a third embodiment. The pitch system 110 differs from the pitch system according to the first embodiment in that the hydraulic motor 12 is configured as a hydraulic motor 12 with variable displacement. A variable pressure line 38 branches off from a connection between the hydraulic motor 12 and the return line 18. In particular, the variable pressure line 38 branches off between the hydraulic motor 12 and a nozzle 40 disposed in the line connecting the hydraulic motor 12 and the return line 18. As shown in FIG. 5, a constant displacement pump 58 is connected to the variable pressure line 38. The constant displacement pump 58 is driven by the shaft 124 i.e., a common shaft with hydraulic motor 12. The constant displacement pump 58 is connected to the tank 20 e.g., via the return line 18. The displacement depends on the pressure signal which is signaled to the hydraulic motor 12 via the variable pressure line 38. This allows the hydraulic motor 12 to utilize the hydraulic energy stored in the hydraulic accumulator 14 more efficiently, as the displacement is directly adjusted according to the prevailing pressure signaled via the variable pressure line 38 which is related to the speed of the hydraulic motor 12, as the latter is directly linked to the constant displacement pump 58 pressurizing the variable pressure line 38. In other words, the displacement of the hydraulic motor 12 depends on the speed of the hydraulic motor 12 which is harmonized with the speed of the constant displacement pump 58. With increasing speed, the pressure signal in the variable pressure line 38 also increases, as the speed of the constant displacement pump 58 increases. The residual pressure in the variable pressure line 38 can be relieved to the reservoir 20 via the nozzle 40 and the return line 18. As the hydraulic motor 12 is a hydraulic motor with variable displacement, it can be displaced to at zero position and the first valve 26 and/or the second valve 28 may be omitted in an alternative embodiment.

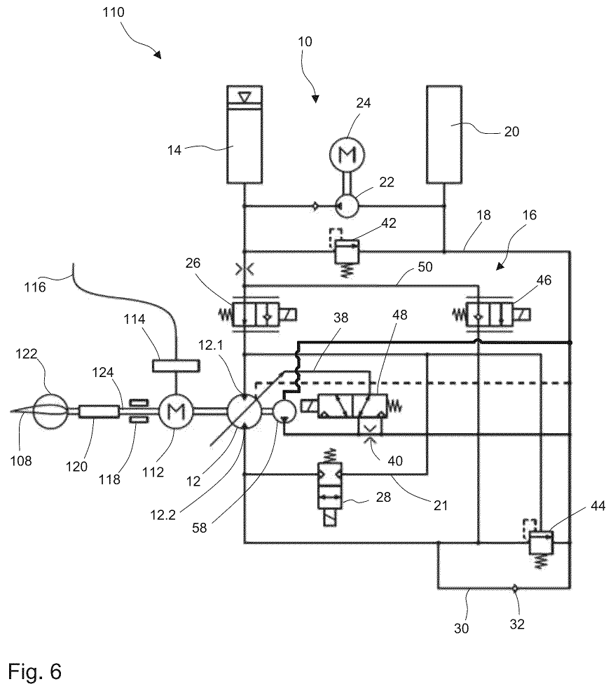

FIG. 6 shows the pitch system 110 according to a fourth embodiment. The pitch system 110 according to the fourth embodiment differs from the pitch system according to the third embodiment in that the hydraulic motor 12 is configured as a bidirectional hydraulic motor 12 with variable displacement. The valve unit 16 is switchable into a first run switch position and into a second run switch position so that the additional force component output by the hydraulic motor 12 as a torque can be applied in both rotational directions to the shaft 124. In particular, when the valve unit 16 is in the first run switch position, the torque of the hydraulic motor 12 is output in a first rotational direction and when the valve unit 16 is in the second run switch position, the torque of the hydraulic motor 12 is output in a second rotational direction which is opposite to the first rotational direction. Therefore, the hydraulic motor 12 can add the output torque to the drive torque of the electric motor 112 in either direction i.e., the first rotational direction or the second rotational direction. Consequently, the electrical motor 112 and inverter 114 can be configured for a lower peak torque, while still being in charge of position tracking even if some of the torque is provided by the hydraulic motor 12. The hydraulic motor 12 of course can also supply torque to the shaft 124 in during an emergency stop use, so that pitch of the rotor blade 108 is possible.

To allow for the first run switch position and the second run switch position, the valve unit 16 comprises a third valve 46 and a fourth valve 48. The first valve 26 and the third valve 46 are configured as proportional 2/2 directional valves. The fourth valve 48 is configured as a 3/2-directional valve. As shown in FIG. 6, the fourth valve 48 is disposed in the variable pressure line 38 so that depending on the switching position of the fourth valve 48 either the pressure relating to the speed of the hydraulic motor 12 or a constant pressure signal is signaled to the hydraulic motor 12. The third valve 46 is disposed in a branch line 50 branching off between the hydraulic accumulator 14 and the first valve 26 with the branch line 50 opening into the line between the hydraulic motor 12 and the second pressure relief valve 42. Depending on the switching positions of the first valve 26 and the second valve 46, the hydraulic pressure delivered from the hydraulic accumulator is applied to the hydraulic motor from either direction.

The fourth valve 48 is configured to signal a constant (low or high) pressure signal via the variable pressure line 38 during the normal operation mode, whereas the pressure signal signaled via the variable pressure line 38 during an emergency stop is related to the speed of the hydraulic motor 12. In other words, during the normal operation mode, the hydraulic motor 12 runs at constant displacement, as speed control of the shaft 124 is conducted via the gearbox 120. During an emergency stop however, a pressure signal relating to the speed of the hydraulic motor 12 is used to control the displacement, so that the capacity of the hydraulic accumulator 14 is utilized in the most efficient way. In an alternative embodiment, the second valve 28 can be omitted. In this case, hydraulic fluid can be sucked via the bypass line 30 when a zero-displacement of the hydraulic motor 12 is deliberately forced e.g., in configuring the fourth valve as a 3/3-directional valve.

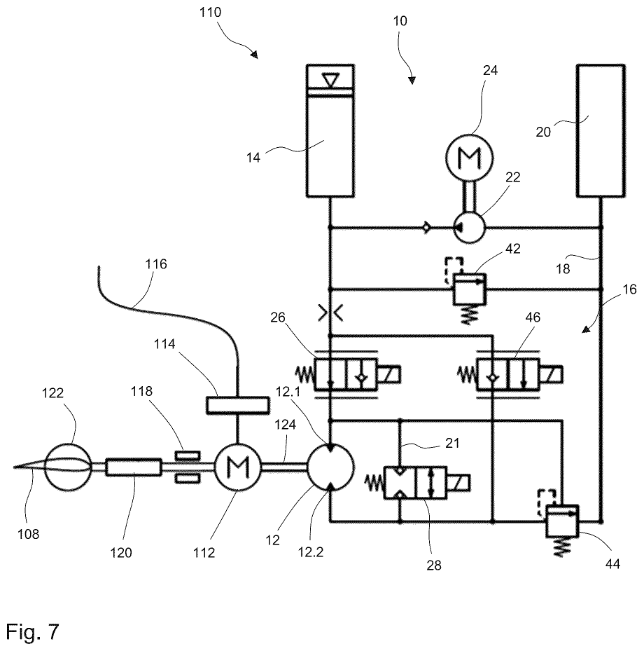

FIG. 7 shows the pitch system 110 according to a fifth embodiment. The pitch system 110 according to the fifth embodiment is similar to the pitch system according to the fourth embodiment and differs from the pitch system according to the fourth embodiment in that the hydraulic motor 12 is only a bidirectional hydraulic motor 12 i.e., without variable displacement. Thus, the fourth valve 48 and the nozzle 40 are not present, as the hydraulic motor is operated at a constant and non-variable displacement, as in the embodiment shown in FIG. 3.

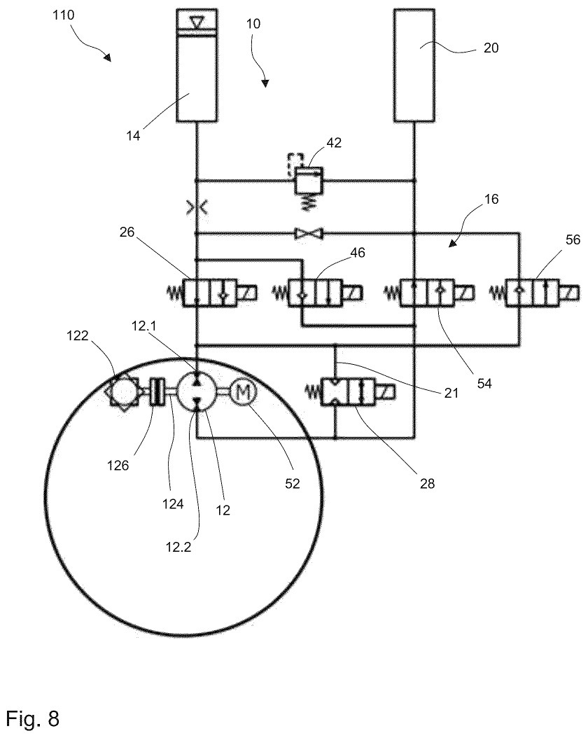

FIG. 8 depicts a pitch system 110 according to a sixth embodiment. The pitch system 110 according to the sixth embodiment comprises a hydraulic motor 12 configured as a bidirectional and reversible hydraulic motor 12. Furthermore, the pitch system 110 according to the sixth embodiment does not comprise an electrical motor, but the additional hydraulic device 10 comprises an electric motor 52 which is intended to drive the hydraulic motor 12 to function as a pump for recharging the hydraulic accumulator 14, as described above in relation to FIG. 3. Therefore, the shaft 124 comprises a clutch 126 which can separate the hydraulic motor 12 from the pitch gear 122 when the hydraulic accumulator 14 is recharged.

Furthermore, the valve unit 16 comprises a fifth valve 54 and sixth valve 56. Depending on the switching positions of the first valve 26, the third valve 46, the fifth valve 54 and the sixth valve 56, the hydraulic motor 12 can either be pressurized via the hydraulic accumulator 14 from one of the two sides, or the hydraulic accumulator 14 can be charged via the hydraulic motor 12 acting as a pump in that hydraulic fluid is sucked from the reservoir 20.

Finally, it has to be emphasized that terms like “first”, “second” or “third” do not imply a certain order, but are merely intended to differentiate between respective features and elements. Furthermore, the valve unit 16 as described above in relation to the various embodiments can be provided in different implementations e.g., as an on/off control, a proportional pressure control, a proportional flow control, etc.

1. A hydraulic device for a pitch system of a wind turbine, the hydraulic device comprising:
a hydraulic motor;
a hydraulic accumulator for storing hydraulic energy;
a valve unit;
a return line;
a reservoir connected to the return line; and
a generator,
wherein:
the valve unit is switchable to a drive switching position,
the hydraulic motor is connected to the hydraulic accumulator in the drive switching position,
the energy stored in the hydraulic accumulator drives the hydraulic motor in the drive switching position so that the hydraulic motor delivers an additional force component, and
the additional force component is applied to the generator to cause the generator to supply electric energy to the pitch system.

2. The hydraulic device of claim 1, further comprising a variable pressure line, wherein the hydraulic motor comprises a variable displacement and is connected to the variable pressure line, wherein a displacement of the hydraulic motor depends on a pressure in the variable pressure line.

3. The hydraulic device of claim 2, further comprising a constant displacement pump connected to the variable pressure line, wherein the constant displacement pump and the hydraulic motor are connected in series.

4. The hydraulic device of claim 2, wherein the hydraulic motor is a bidirectional hydraulic motor with a variable displacement, wherein the valve unit is switchable into a first run switch position and into a second run switch position, wherein the additional force component of the hydraulic motor is a torque, and wherein the torque is output in a first rotational direction in the first run switch position and in a second rotational direction in the second run switch position.

5. The hydraulic device of claim 1, further comprising a charging pump, wherein the valve unit is switchable to a charging switch position connecting the charging pump to the return line and the hydraulic accumulator, and wherein the charging pump charges the hydraulic accumulator with hydraulic energy in the charging switch position.

6. The hydraulic device of claim 1, wherein the hydraulic motor is a reversible hydraulic motor, wherein the valve unit is switchable to a charging switch position connecting the reversible hydraulic motor to the return line and the hydraulic accumulator, and wherein an electric motor of the pitch system of the wind turbine is configured to drive the reversible hydraulic motor in the charging switch position so that the reversible hydraulic motor charges the hydraulic accumulator with hydraulic energy in the charging switch position.

7. The hydraulic device of claim 6, wherein the reservoir is connected to the reversible hydraulic motor via a bypass line, wherein a check valve opening in a direction of flow to the reversible hydraulic motor is disposed in the bypass line.

8. A hydraulic device for a pitch system of a wind turbine, the hydraulic device comprising:
a hydraulic motor having a first connection and a second connection;
a hydraulic accumulator for storing hydraulic energy;
a valve unit;
a return line;
a reservoir connected to the return line; and
a circulation line,
wherein:
the first connection is connected to the second connection via the circulation line,
the valve unit is switchable to a drive switching position and a normal operation switching position,
the hydraulic motor is connected to the hydraulic accumulator in the drive switching position and the circulation line is blocked in the drive switching position,
the energy stored in the hydraulic accumulator drives the hydraulic motor in the drive switching position so that the hydraulic motor delivers an additional force component, and
the hydraulic motor is separated from the hydraulic accumulator in the normal operation switching position and wherein the circulation line is released in the normal operation switching position.

9. The hydraulic device of claim 8, further comprising a variable pressure line, wherein the hydraulic motor comprises a variable displacement and is connected to the variable pressure line, wherein a displacement of the hydraulic motor depends on a pressure in the variable pressure line.

10. The hydraulic device of claim 9, further comprising a constant displacement pump connected to the variable pressure line, wherein the constant displacement pump and the hydraulic motor are connected in series.

11. The hydraulic device of claim 9, wherein the hydraulic motor is a bidirectional hydraulic motor with a variable displacement, wherein the valve unit is switchable into a first run switch position and into a second run switch position, wherein the additional force component of the hydraulic motor is a torque, and wherein the torque is output in a first rotational direction in the first run switch position and in a second rotational direction in the second run switch position.

12. The hydraulic device of claim 8, further comprising a charging pump, wherein the valve unit is switchable to a charging switch position connecting the charging pump to the return line and the hydraulic accumulator, and wherein the charging pump charges the hydraulic accumulator with hydraulic energy in the charging switch position.

13. The hydraulic device of claim 8, wherein the hydraulic motor is a reversible hydraulic motor, wherein the valve unit is switchable to a charging switch position connecting the reversible hydraulic motor to the return line and the hydraulic accumulator, and wherein an electric motor of the pitch system of the wind turbine is configured to drive the reversible hydraulic motor in the charging switch position so that the reversible hydraulic motor charges the hydraulic accumulator with hydraulic energy in the charging switch position.

14. The hydraulic device of claim 13, wherein the reservoir is connected to the reversible hydraulic motor via a bypass line, wherein a check valve opening in a direction of flow to the reversible hydraulic motor is disposed in the bypass line.

15. A pitch system for a wind turbine, the pitch system comprising a hydraulic device having:
a hydraulic motor;
a hydraulic accumulator for storing hydraulic energy;
a valve unit;
a return line;
a reservoir connected to the return line; and
a generator,
wherein:
the valve unit is switchable to a drive switching position,
the hydraulic motor is connected to the hydraulic accumulator in the drive switching position, and
the energy stored in the hydraulic accumulator drives the hydraulic motor in the drive switching position so that the hydraulic motor delivers an additional force component, and
the additional force component is applied to the generator to cause the generator to supply electric energy to the pitch system.

16. The pitch system of claim 15, further comprising an electric motor for adapting a pitch of at least one rotor blade of the wind turbine.

17. The pitch system of claim 16, wherein the electric motor and the hydraulic motor are connected in series.

18. The pitch system of claim 16, further comprising a clutch for separating the electric motor and/or the hydraulic motor from at least one rotor blade.

19. A wind turbine, comprising
at least one rotor blade; and
a pitch system, the pitch system having a hydraulic device comprising:
a hydraulic motor;
a hydraulic accumulator for storing hydraulic energy;
a valve unit;
a return line;
a reservoir connected to the return line; and
a generator,
wherein:
the valve unit is switchable to a drive switching position,
the hydraulic motor is connected to the hydraulic accumulator in the drive switching position, and
the energy stored in the hydraulic accumulator drives the hydraulic motor in the drive switching position so that the hydraulic motor delivers an additional force component, and the additional force component is applied to the generator to cause the generator to supply electric energy to the pitch system.

20. The wind turbine of claim 19, further comprising an electric motor for adapting a pitch of at least one rotor blade.
